(19) United States
(12) Patent Application Publication
(10) Pub. No.: US 2025/0148163 A1
(43) Pub. Date: May 8, 2025

(54) METHOD OF OPTIMIZING RESOURCE ALLOCATION BASED ON ADAPTIVE MULTI-FACETED CUTTING OF POWER DISPATCHING MODEL

(71) Applicant: Shanghai Jiao Tong University, Minhang District, Shanghai (CN)

(72) Inventors: Xu WANG, Minhang District, Shanghai (CN); Ke ZHANG, Minhang District, Shanghai (CN); Chuanwen JIANG, Minhang District, Shanghai (CN); Shenxi ZHANG, Minhang District, Shanghai (CN); Qizhen CHEN, Minhang District, Shanghai (CN); Hongkun YANG, Minhang District, Shanghai (CN); Hanxiao WU, Minhang District, Shanghai (CN)

(21) Appl. No.: 18/888,643

(22) Filed: Sep. 18, 2024

(30) Foreign Application Priority Data
Nov. 7, 2023 (CN) 202311465228.3

(51) Int. Cl. G06F 30/20

(52) U.S. Cl. CPC G06F 30/20

(57) ABSTRACT

A method of optimizing resource allocation based on adaptive multi-faceted cutting of a power dispatching model is provided. The method includes constructing and analyzing a two-stage distributed robust model by using acquired operation state information of a power system and identifying therefrom a second-stage infinite-dimensional decision variable. A model is reconstructed by dimensionality reduction and a dispatching model is solved to obtain a dispatching strategy scheme for realizing optimal resource allocation. The two-stage distributed robust dispatching model is transformed into a finite-dimensional problem, so that rapid solution is realized. By improving the solving efficiency and the accuracy of the power dispatching model, the working efficiency of the power system is obviously improved.

### CROSS-REFERENCE TO RELATED APPLICATION

This patent application claims the benefit and priority of Chinese Patent Application No. 202311465228.3 filed with the China National Intellectual Property Administration on Nov. 7, 2023, the disclosure of which is incorporated by reference herein in its entirety as part of the present application.

### TECHNICAL FIELD

The present disclosure relates to a technology in the field of power dispatching, in particular to a method of optimizing resource allocation based on adaptive multi-faceted cutting of a power dispatching model.

### BACKGROUND

The existing dual solution methods show the problems of a slow solution speed, a large approximate error and a difficult measurement in distributed robust optimization, which leads to insufficient accuracy of the solution results and is not conducive to the safe and stable dispatch of a power system. The existing external estimation algorithm can only solve a location model of an electric vehicle switching station.

### SUMMARY

Aiming at the infinite-dimensional solution problem in the existing distributed robust optimization problem, the present disclosure provides a method of optimizing resource allocation based on adaptive multi-faceted cutting of a power dispatching model. A two-stage distributed robust dispatching model is transformed into a finite-dimensional problem through the adaptive multi-faceted approximation method, so that rapid solution is realized. By improving the solving efficiency and the accuracy of the power dispatching model, the working efficiency of the power system is obviously improved.

The present disclosure is realized by the following technical scheme.

The present disclosure relates to a method of optimizing resource allocation based on adaptive multi-faceted cutting of a power dispatching model, including: constructing and analyzing a two-stage distributed robust model by using acquired operation state information of a power system, and identifying therefrom a second-stage infinite-dimensional decision variable, reconstructing a model by dimensionality reduction, where the model is a dispatching model optimized based on the robust, and solving a reconstructed dispatching model to obtain a dispatching strategy scheme for realizing optimal resource allocation.

The acquired operation state information of the power system refers to a node voltage, currents of a transmission line, a transformer and other devices, a load point, active power consumption and reactive power consumption of a generator, states of a switch and a circuit breaker, state and setting of a protection device, a working frequency of a system, temperature of the transformer, a cable or the generator, network fault information and external environment information.

The two-stage distributed robust model refers to: determining a preliminary decision by considering existing information and a description of uncertainty, that is, a first stage; and performing decision adjustment again under the most unfavorable situation of the decision, that is, a second stage, to ensure the lowest performance standard; wherein the uncertainty is described by a set of predicted probability distributions.

An objective function of the two-stage distributed robust model, that is, an objective function of a distributed robust original problem [symbol] , is

$${min}_{x ∈ {ℝ}^{n}} {c}^{T} x + \frac{1}{N} {\sum }_{i = {1}_{ζ ∈ {F}^{i} ( {ε}_{N} )}}^{N} sup Q ( x , ζ ) ,$$

the constraint is Tx+Wy≥m(ζ), and h(x,y,ζ)=0, wherein T∈ [symbol] ^{m×n}, W∈ [symbol] ^{m×r}, the affine function is m(ζ)=m⁰+Mζ∈ [symbol] ^{m}, x and y are a first-stage decision variable and the second-stage infinite-dimensional decision variable, respectively, Q(x, ζ) is a second-stage objective function, c is an objective function coefficient matrix, T and W are inequality coefficient matrices, m(ζ) is a vector of an inequality constraint, and h(x,y,ζ)=0 is an equality constraint.

The second-stage objective function is

$$Q ( x , ζ ) {=}^{Δ} {min}_{y ∈ {ℝ}^{d , r}} {q}^{T} y ,$$

wherein q is a coefficient of the second-stage objective function, T is a corresponding transpose matrix, and a function space [symbol] ^{d}→ [symbol] ^{r} of the second-stage infinite-dimensional decision variable y(⋅) is represented by [symbol] ^{d,r}.

The identifying refers to limiting the second-stage infinite-dimensional decision variable y to a space smaller than an original feasible domain [symbol] ^{d,r}, that is, constructing a limited second-stage infinite-dimensional decision variable space using π⊆ [symbol] ^{d,r}, and carrying out an approximate process on the distributed robust original problem [symbol] to obtain [symbol] , wherein a result obtained after approximation is a suboptimal solution, that is, min [symbol] ≤min [symbol] .

The reconstructing a model by dimensionality reduction refers to: reducing a feasible domain range Π, y(ξ)=y⁰+Yξ of the second-stage infinite-dimensional decision variable y by single-plane cutting based on an idea of an approximation method, to obtain

$${min}_{x ∈ {ℝ}^{n} , y ( \cdot ) ∈ π} {c}^{T} x + \frac{1}{N} {\sum }_{i = {1}_{ζ ∈ {F}^{i} ( {ε}_{N} )}}^{N} sup {q}^{T} y ( ζ ) ,$$

Tx+Wy≥m(ζ), and h(x,y,ζ)=0, where q∈ [symbol] ^{r}, y⁰∈ [symbol] ^{r}, a decision variable matrix is Y∈ [symbol] ^{r×d}; and performing extension by inheriting the idea of the approximation method of limiting and searching for a feasible domain of the variables, to obtain a reconstructed dispatching model after the adaptive multi-faceted cutting:

$${min}_{{x ∈ {ℝ}^{n} ,}_{{y}^{1} ( \cdot ) ⋯ {y}^{N} ( \cdot ) ∈ π}} {c}^{T} x + \frac{1}{N} {\sum }_{i = {1}_{ζ ∈ {F}^{i} ( {ε}_{N} )}}^{N} sup {q}^{T} {y}^{i} ( ζ )$$

Tx+Wy≥m(ζ), i∈[N], and h(x,y,ζ)=0, where x and y are a first-stage decision variable and the second-stage infinite-dimensional decision variable, respectively,

$$\frac{1}{N} {\sum }_{i = {1}_{ζ ∈ {F}^{i} ( {ε}_{N} )}}^{N} sup {q}^{T} {y}^{i} ( ζ )$$

is an approximated second-stage objective function, c is an objective function coefficient matrix, T and W are inequality coefficient matrices, m(ζ) is a vector of an inequality constraint, and h(x,y,ζ)=0 is an equality constraint.

The dispatching strategy scheme is obtained by solving the reconstructed dispatching model by using a column-generated cutting plane method, specifically including:
i) solving the reconstructed dispatching model by using a simplified model containing only a subset of variables;
ii) gradually increasing variables in a current solution that have negative reduction costs or contribute to the improvement of the objective function, that is, generating columns, so as to find the optimal solution of linear relaxation and eliminate the current non-integer solution without eliminating any integer feasible solution;
iii) when the optimal solution of linear relaxation does not satisfy a integer constraint, generating a new constraint by using a reduced constraint method, and then returning to Step ii until an integer solution satisfying all constraints is found or the problem is determined to have no solution; and
iv) when there are no new generated columns, that is, all columns have non-negative reduction costs and the current solution satisfies all integer constraints, obtaining the dispatching strategy scheme.

### BRIEF DESCRIPTION OF THE DRAWINGS

FIG. 1 is a schematic diagram of a system according to the present disclosure.

FIG. 2 is a schematic flow diagram according to the present disclosure.

FIG. 3 is a result diagram of a dispatching strategy according to the embodiment.

### DETAILED DESCRIPTION OF THE EMBODIMENTS

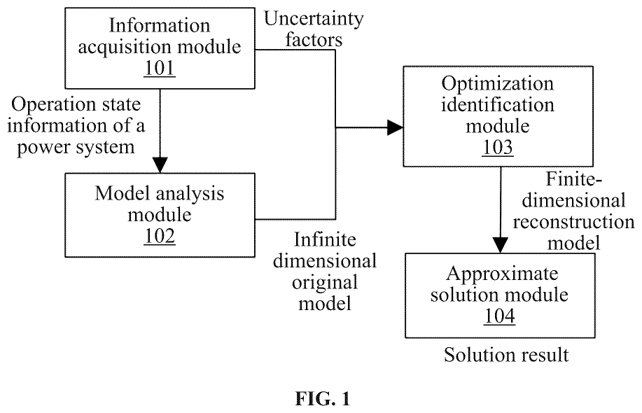

As shown in FIG. 1, this embodiment relates to a two-stage distributed robust model-oriented adaptive multi-faceted cutting solution system, including an information acquisition module 101, a model analysis module 102, a model reconstruction module (e.g. an optimization identification module 103 shown in FIG. 1) and an approximate solution module 104, wherein the information acquisition module 101 is connected with a power system and is configured to acquire operation data, power demand information and possible uncertainty information in the power system in real time; the model analysis module 102 is connected with the information acquisition module 101 and is configured to primarily process and analyze information acquired to form a data format suitable for the distributed robust model; the model reconstruction module is connected with the model analysis module 102, and is configured to reduce the dimension of the second-stage infinite-dimensional decision variable of the model by using an adaptive multi-faceted cutting method based on the analyzed data, to reconstruct the two-stage distributed robust model; and the approximate solution module 104 is connected with the reconstruction module, and is configured to quickly solve the reconstructed distributed robust model and generate the dispatching strategy scheme.

For the model, according to the operation state information of the power system acquired by the information acquisition module 101, a two-stage distributed robust model is established through the model analysis module 102 and its second-stage infinite-dimensional decision variables are identified, which then are imported into the model reconstruction module to reconstruct the model by dimensionality reduction according to the uncertainty information; and finally, the reconstructed model is imported into a solver for solution to obtain a dispatching strategy result.

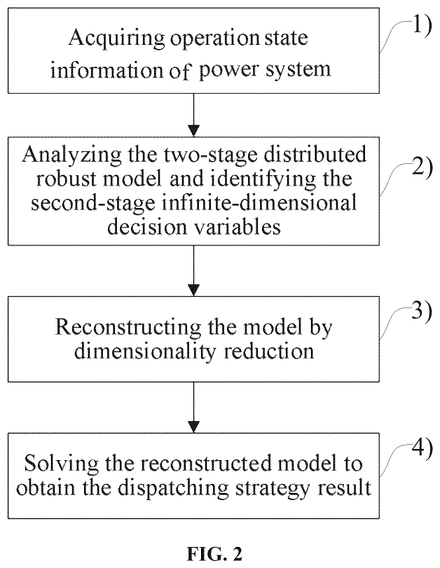

As shown in FIG. 2, the method of optimizing resource allocation based on adaptive multi-faceted cutting of the power dispatching model based on the above system in this embodiment includes steps 1)-4).

In step 1), IEEE-118 nodes are used as a detection system, and a distributed robust optimal dispatching model of the power system is constructed. Under considering the uncertainty of wind power, the day-ahead dispatching plan of the power system is determined, the operation state of the system is balanced by being flexibly involved in the second-stage standby dispatching, and the dispatching scheme with the optimal dispatching strategy economy is determined.

In step 2), the distributed robust optimal dispatching model of the power system is analyzed, and its second-stage infinite-dimensional decision variables are identified.

In step 3), according to the uncertainty information, the second-stage infinite-dimensional decision variables of the model are reconstructed by dimensionality reduction to obtain a finite-dimensional model.

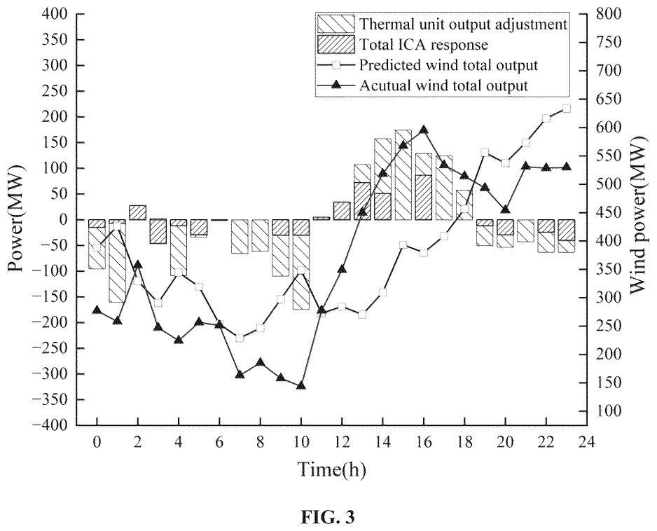

In step 4), the reconstructed model is imported into the solver to obtain the dispatching strategy result, as shown in FIG. 3.

After specific practical experiments, the day-ahead dispatching plan of the power system is determined on IEEE-118 nodes under considering the uncertainty of wind power. The dispatching results of the test system using a multi-faceted cutting algorithm are compared with those using a traditional sample average algorithm (SAA), a single-faceted cutting strategy and a robust optimization method. The total system dispatching cost, the used calculation time and the wind curtailment and load shedding rate of the dispatching scheme in the out-of-sample data obtained by solving the distributed robust model with different approximate algorithms are shown in Table 1.

TABLE 1

| | | wind curtailment | |
|---|---|---|---|
| | Total system | and load shedding | |
| Solving | dispatching | rate outside the | calculation |
| model/method | cost/$ | sample/% | time/s |
| SAA | 1271305 | 12.3 | 38010 |
| multi-faceted cutting | 1319156 | 0.5 | 279 |
| single-faceted cutting | 1325782 | 4.6 | 353 |
| robust optimization | 1478957 | 0 | 403 |

As can be seen from Table 1, the calculation time of the present disclosure is significantly lower than the SAA, and slightly faster than single-faceted cutting, thus effectively reducing the burden of two-stage distributed robust calculation. Although the SAA has the lowest operating cost, it also brings a high wind curtailment and load shedding rate in the wind power scene outside the sample. This is because it is difficult to include small probability cases in the limited historical samples considered by the SAA, and this approximate result is not poor in robustness. The method of the present disclosure greatly reduces the wind curtailment and load shedding rate of the operation result outside the sample, which not only effectively overcomes the shortcoming that the traditional robust method is too conservative in decision-making, but also is more reasonable compared with the traditional approximation method. This balances the robustness and economy of the system dispatching result on the one hand, and improves the solving speed and the accuracy of the model on the other hand.

The present disclosure relates to a method of optimizing resource allocation based on adaptive multi-faceted cutting of a power dispatching model, including: constructing and analyzing a two-stage distributed robust model by using acquired operation state information of a power system, and identifying therefrom a second-stage infinite-dimensional decision variable, reconstructing a model by dimensionality reduction, where the model is a dispatching model optimized based on the robust, and solving a reconstructed dispatching model to obtain a dispatching strategy scheme for realizing optimal resource allocation.

The acquired operation state information of the power system refers to a node voltage, currents of a transmission line, a transformer and other devices, a load point, active power consumption and reactive power consumption of a generator, states of a switch and a circuit breaker, state and setting of a protection device, a working frequency of a system, temperature of the transformer, a cable or the generator, network fault information and external environment information.

The two-stage distributed robust model refers to: determining a preliminary decision by considering existing information and a description of uncertainty, that is, a first stage; and performing decision adjustment again under the most unfavorable situation of the decision, that is, a second stage, to ensure the lowest performance standard; wherein the uncertainty is described by a set of predicted probability distributions.

An objective function of the two-stage distributed robust model, that is, an objective function of a distributed robust original problem [symbol] , is

$${min}_{x ∈ {ℝ}^{n}} {c}^{T} x + \frac{1}{N} {\sum }_{i = {1}_{ζ ∈ {F}^{i} ( {ε}_{N} )}}^{N} sup Q ( x , ζ ) ,$$

the constraint is Tx+Wy≥m(ζ), and h(x,y,ζ)=0, wherein T∈ [symbol] ^{m×n}, W∈ [symbol] ^{m×r}, the affine function is m(ζ)=m⁰+Mζ∈ [symbol] ^{m}, x and y are a first-stage decision variable and the second-stage infinite-dimensional decision variable, respectively, Q(x,ζ) is a second-stage objective function, c is an objective function coefficient matrix, T and W are inequality coefficient matrices, m(ζ) is a vector of an inequality constraint, and h(x,y,ζ)=0 is an equality constraint.

The second-stage objective function is

$$Q ( x , ζ ) {=}^{Δ} {min}_{y ∈ {ℝ}^{d , r}} {q}^{T} y ,$$

wherein q is a coefficient of the second-stage objective function, T is a corresponding transpose matrix, and a function space [symbol] ^{d}→ [symbol] ^{r} of the second-stage infinite-dimensional decision variable y(⋅) is represented by [symbol] ^{d,r}.

The identifying refers to limiting the second-stage infinite-dimensional decision variable y to a space smaller than an original feasible domain [symbol] ^{d,r}, that is, constructing a limited second-stage infinite-dimensional decision variable space using Π⊆ [symbol] ^{d,r}, and carrying out an approximate process on the distributed robust original problem [symbol] to obtain [symbol] , wherein a result obtained after approximation is a suboptimal solution, that is, min [symbol] ≤min [symbol] .

The reconstructing a model by dimensionality reduction refers to: reducing a feasible domain range Π, y(ξ)=y⁰+Yξ of the second-stage infinite-dimensional decision variable y by single-plane cutting based on an idea of an approximation method, to obtain

$${min}_{x ∈ {ℝ}^{N} , y ( \cdot ) ∈ π} {c}^{T} x + \frac{1}{N} {\sum }_{i = {1}_{ζ ∈ {F}^{i} ( {ε}_{N} )}}^{N} sup {q}^{T} y ( ζ ) ,$$

Tx+Wy≥m(ζ) and h(x,y,ζ)=0, where q∈ [symbol] ^{r}, y⁰∈ [symbol] ^{r}, a decision variable matrix is Y∈ [symbol] ^{r×d}; and performing extension by inheriting the idea of the approximation method of limiting and searching for a feasible domain of the variables, to obtain a reconstructed dispatching model after the adaptive multi-faceted cutting:

$${min}_{{x ∈ {ℝ}^{n} ,}_{{y}^{1} ( \cdot ) ⋯ {y}^{N} ( \cdot ) ∈ π}} {c}^{T} x + \frac{1}{N} {\sum }_{i = {1}_{ζ ∈ {F}^{i} ( {ε}_{N} )}}^{N} sup {q}^{T} {y}^{i} ( ζ )$$

Tx+Wy≥m(ζ), i∈[N], and h(x,y,ζ)=0, where x and y are a first-stage decision variable and the second-stage infinite-dimensional decision variable, respectively,

$$\frac{1}{N} {\sum }_{i = {1}_{ζ ∈ {F}^{i} ( {ε}_{N} )}}^{N} sup {q}^{T} {y}^{i} ( ζ )$$

is an approximated second-stage objective function, c is an objective function coefficient matrix, T and W are inequality coefficient matrices, m(ζ) is a vector of an inequality constraint, and h(x,y,ζ)=0 is an equality constraint.

The dispatching strategy scheme is obtained by solving the reconstructed dispatching model by using a column-generated cutting plane method, specifically including:
i) solving the reconstructed dispatching model by using a simplified model containing only a subset of variables;
ii) gradually increasing variables in a current solution that have negative reduction costs or contribute to the improvement of the objective function, that is, generating columns, so as to find the optimal solution of linear relaxation and eliminate the current non-integer solution without eliminating any integer feasible solution;
iii) when the optimal solution of linear relaxation does not satisfy a integer constraint, generating a new constraint by using a reduced constraint method, and then returning to Step ii until an integer solution satisfying all constraints is found or the problem is determined to have no solution; and
iv) when there are no new generated columns, that is, all columns have non-negative reduction costs and the current solution satisfies all integer constraints, obtaining the dispatching strategy scheme.

### Technical Effect

According to the present disclosure, acquired operation state information of a power system is used to construct and analyze a two-stage distributed robust model, and identify from it to obtain a second-stage infinite-dimensional decision variable; the model is reconstructed by dimensionality reduction, and then a reconstructed dispatching model is solved to obtain a dispatching strategy scheme to realize optimal resource allocation. Compared with the prior art, the present disclosure not only greatly improves the solution speed, but also effectively reduces the approximation error, ensures the accuracy of the solution result, and provides an efficient and accurate solution scheme for the power system dispatching model. According to the present disclosure, the uncertain factors in the power distribution robust dispatching model are deeply excavated, and the complex infinite-dimensional problem is effectively transformed into a more concise finite-dimensional model through an adaptive multi-surface approximation method. This is not deeply discussed and realized in the previous research. The technical effect is that the solution scheme of a power dispatching model based on adaptive multi-faceted cutting is established, and the goal of solving distributed robust problems quickly is achieved. This model not only significantly improves the time efficiency, but also improves the accuracy and the reliability compared with other approximate solutions, providing a more robust and reliable tool for dispatching a power system, thus ensuring the efficient and safe operation of the power system.

Compared with the prior art, the present disclosure transforms the infinite dimension characteristics of the distributed robust optimization problem by using the adaptive multi-faceted cutting solution method, thus avoiding the dimension disaster, ensuring the high accuracy of the approximate solution, realizing fast and accurate problem solution, providing a more scientific and comprehensive data basis for dispatching decision makers, and further ensuring the stable and efficient operation of the power system.

The above detailed description can be partially adjusted by those skilled in the art in different ways without departing from the principle and purpose of the present disclosure. The scope of protection of the present disclosure is subject to the claims and is not limited by the above detailed description, and all implementations within its scope are bound by the present disclosure.

What is claimed is:

1. A method of optimizing resource allocation based on adaptive multi-faceted cutting of a power dispatching model, comprising:
constructing and analyzing a two-stage distributed robust model by using acquired operation state information of a power system, and identifying therefrom a second-stage infinite-dimensional decision variable;
reconstructing a model by dimensionality reduction; and
solving a reconstructed dispatching model to obtain a dispatching strategy scheme for realizing optimal resource allocation;
wherein the acquired operation state information of the power system comprises a node voltage, currents of a transmission line, a transformer and other devices, a load point, active power consumption and reactive power consumption of a generator, states of a switch and a circuit breaker, state and setting of a protection device, a working frequency of a system, temperature of the transformer, a cable or the generator, network fault information and external environment information.

2. The method according to claim 1, wherein the two-stage distributed robust model comprises: determining a preliminary decision by considering existing information and a description of uncertainty, that is, a first stage; and performing decision adjustment again under a most unfavorable situation of the decision, that is, a second stage, to ensure a lowest performance standard; wherein the uncertainty is described by a set of predicted probability distributions.

3. The method according to claim 1, wherein an objective function of the two-stage distributed robust model, that is, an objective function of a distributed robust original problem P, is
$${min}_{x ∈ {ℝ}^{n}} {c}^{T} x + \frac{1}{N} {\sum }_{i = {1}_{ζ ∈ {F}^{i} ( {ε}_{N} )}}^{N} sup Q ( x , ζ ) ,$$
a constraint is Tx+Wy≥m(ζ), and h(x,y,ζ)=0, wherein T∈ [symbol] ^{m×n}, W∈ [symbol] ^{m×r}, a affine function is m(ζ)=m⁰+Mζ∈ [symbol] ^{m}, x and y are a first-stage decision variable and the second-stage infinite-dimensional decision variable, respectively, Q(x,ζ) is a second-stage objective function, c is an objective function coefficient matrix, T and W are inequality coefficient matrices, m(ζ) is a vector of an inequality constraint, and h(x,y,ζ)=0 is an equality constraint.

4. The method according to claim 2, wherein an objective function of the two-stage distributed robust model, that is, an objective function of a distributed robust original problem P, is
$${min}_{x ∈ {ℝ}^{n}} {c}^{T} x + \frac{1}{N} {\sum }_{i = {1}_{ζ ∈ {F}^{i} ( {ε}_{N} )}}^{N} sup Q ( x , ζ ) ,$$
a constraint is Tx+Wy≥m(ζ), and h(x,y,ζ)=0, wherein T∈ [symbol] ^{m×n}, W∈ [symbol] ^{m×r}, a affine function is m(ζ)=m⁰+Mζ∈ [symbol] ^{m}, x and y are a first-stage decision variable and the second-stage infinite-dimensional decision variable, respectively, Q(x,ζ) is a second-stage objective function, c is an objective function coefficient matrix, T and W are inequality coefficient matrices, m(ζ) is a vector of an inequality constraint, and h(x,y,ζ)=0 is an equality constraint.

5. The method according to claim 3, wherein the second-stage objective function is
$$Q ( x , ζ ) {=}^{△} {min}_{y ∈ {ℝ}^{d , r}} {q}^{T} y ,$$
wherein q is a coefficient of the second-stage objective function, T is a corresponding transpose matrix, and a function space [symbol] ^{d}→ [symbol] ^{r} of the second-stage infinite-dimensional decision variable y(⋅) is represented by [symbol] ^{d,r}.

6. The method according to claim 4, wherein the second-stage objective function is
$$Q ( x , ζ ) {=}^{△} {min}_{y ∈ {ℝ}^{d , r}} {q}^{T} y ,$$
wherein q is a coefficient of the second-stage objective function, T is a corresponding transpose matrix, and a function space [symbol] ^{d}→ [symbol] ^{r} of the second-stage infinite-dimensional decision variable y(·) is represented by [symbol] ^{d,r}.

7. The method according to claim 1, wherein the identifying refers to limiting the second-stage infinite-dimensional decision variable y to a space smaller than an original feasible domain [symbol] ^{d,r}, that is, constructing a limited second-stage infinite-dimensional decision variable space using Π⊆ [symbol] ^{d,r}, and carrying out an approximate process on a distributed robust original problem [symbol] to obtain [symbol] , wherein a result obtained after approximation is a suboptimal solution, that is, min [symbol] ≤min [symbol] .

8. The method according to claim 1, wherein the reconstructing a model by dimensionality reduction refers to: reducing a feasible domain range Π, y(ξ)=y⁰+Yξ of the second-stage infinite-dimensional decision variable y by single-plane cutting based on an idea of an approximation method, to obtain
$${min}_{{x ∈ {ℝ}^{N} ,}_{{y}^{1} ( \cdot ) … {y}^{N} ( \cdot ) ∈ Π}} {c}^{T} x + \frac{1}{N} {\sum }_{i = {1}_{ζ ∈ {F}^{i} ( {ε}_{N} )}}^{N} sup {q}^{T} {y}^{i} ( ζ )$$
Tx+Wy≥m(ζ), and h(x,y,ζ)=0, wherein q∈ [symbol] ^{r}, y⁰∈ [symbol] ^{r}, a decision variable matrix is Y∈ [symbol] ^{r×d}; and performing extension by inheriting the idea of the approximation method of limiting and searching for a feasible domain of variables, to obtain a reconstructed dispatching model after the adaptive multi-faceted cutting:
$${{min}_{x ∈ {ℝ}^{N} ,}}_{{y}^{1} ( \cdot ) … {y}^{N} ( \cdot ) ∈ Π} {c}^{T} x + \frac{1}{N} {\sum }_{i = {1}_{ζ ∈ {F}^{i} ( {ε}_{N} )}}^{N} sup {q}^{T} {y}^{i} ( ζ )$$
Tx+Wy≥m(ζ), i∈[N], and h(x,y,ζ)=0, wherein x and y are a first-stage decision variable and the second-stage infinite-dimensional decision variable, respectively,
$$\frac{1}{N} {\sum }_{i = {1}_{ζ ∈ {F}^{i} ( {ε}_{N} )}}^{N} sup {q}^{T} {y}^{i} ( ζ )$$
is an approximated second-stage objective function, c is an objective function coefficient matrix, T and W are inequality coefficient matrices, m(ζ) is a vector of an inequality constraint, and h(x,y,ζ)=0 is an equality constraint.

9. The method according to claim 1, wherein the dispatching strategy scheme is obtained by solving the reconstructed dispatching model by using a column-generated cutting plane method, comprising:
i) solving the reconstructed dispatching model by using a simplified model containing only a subset of variables;
ii) gradually increasing variables in a current solution that have negative reduced costs or contribute to an improvement of an objective function, that is, generating columns, to find an optimal solution of linear relaxation and eliminate a current non-integer solution without eliminating any integer feasible solution;
iii) when the optimal solution of linear relaxation does not satisfy a integer constraint, generating a new constraint by using a reduced constraint method, and then returning to Step ii until an integer solution satisfying all constraints is found or a problem is determined to have no solution; and
iv) when there are no new generated columns, that is, all columns have non-negative reduction costs and the current solution satisfies all integer constraints, obtaining the dispatching strategy scheme.

10. A two-stage distributed robust model-oriented adaptive multi-faceted cutting solution system for implementing the method of claim 1, comprising:
an information acquisition module, a model analysis module, a model reconstruction module and an approximate solution module, wherein
the information acquisition module is connected with the power system and is configured to acquire operation data, power demand information and possible uncertainty information in the power system in real time;
the model analysis module is connected with the information acquisition module and is configured to primarily process and analyze information acquired to form a data format suitable for the distributed robust model;
the model reconstruction module is connected with the model analysis module, and is configured to reduce dimension of the second-stage infinite-dimensional decision variable of the model by using an adaptive multi-faceted cutting method based on data analyzed, to reconstruct the two-stage distributed robust model; and
the approximate solution module model is connected with the reconstruction module, and is configured to quickly solve the reconstructed distributed robust model and generate the dispatching strategy scheme.

11. The two-stage distributed robust model-oriented adaptive multi-faceted cutting solution system according to claim 10, wherein the two-stage distributed robust model comprises: determining a preliminary decision by considering existing information and a description of uncertainty, that is, a first stage; and performing decision adjustment again under a most unfavorable situation of the decision, that is, a second stage, to ensure a lowest performance standard; wherein the uncertainty is described by a set of predicted probability distributions.

12. The two-stage distributed robust model-oriented adaptive multi-faceted cutting solution system according to claim 10, wherein an objective function of the two-stage distributed robust model, that is, an objective function of a distributed robust original problem P, is
$${min}_{x ∈ {ℝ}^{n}} {c}^{T} x + \frac{1}{N} {\sum }_{i = {1}_{ζ ∈ {F}^{i} ( {ε}_{N} )}}^{N} sup Q ( x , ζ ) ,$$
a constraint is Tx+Wy≥m(ζ), and h(x,y,ζ)=0, wherein T∈ [symbol] ^{m×n}, W∈ [symbol] ^{m×r}, a affine function is m(ζ)=m⁰+Mζ∈ [symbol] ^{m}, x and y are a first-stage decision variable and the second-stage infinite-dimensional decision variable, respectively, Q(x,ζ) is a second-stage objective function, c is an objective function coefficient matrix, T and W are inequality coefficient matrices, m(ζ) is a vector of an inequality constraint, and h(x,y,ζ)=0 is an equality constraint.

13. The two-stage distributed robust model-oriented adaptive multi-faceted cutting solution system according to claim 11, wherein an objective function of the two-stage distributed robust model, that is, an objective function of a distributed robust original problem P, is
$${min}_{x ∈ {ℝ}^{n}} {c}^{T} x + \frac{1}{N} {\sum }_{i = {1}_{ζ ∈ {F}^{i} ( {ε}_{N} )}}^{N} sup Q ( x , ζ ) ,$$
a constraint is Tx+Wy≥m(ζ), and h(x,y,ζ)=0, wherein T∈ [symbol] ^{m×n}, W∈ [symbol] ^{m×r}, a affine function is m(ζ)=m⁰+Mζ∈ [symbol] ^{m}, x and y are a first-stage decision variable and the second-stage infinite-dimensional decision variable, respectively, Q(x,ζ) is a second-stage objective function, c is an objective function coefficient matrix, T and W are inequality coefficient matrices, m(ζ) is a vector of an inequality constraint, and h(x,y,ζ)=0 is an equality constraint.

14. The two-stage distributed robust model-oriented adaptive multi-faceted cutting solution system according to claim 12, wherein the second-stage objective function is
$$Q ( x , ζ ) {=}^{△} {min}_{y ∈ {ℝ}^{d , r}} {q}^{T} y ,$$
wherein q is a coefficient of the second-stage objective function, T is a corresponding transpose matrix, and a function space [symbol] ^{d}→ [symbol] ^{r} of the second-stage infinite-dimensional decision variable y(⋅) is represented by [symbol] ^{d,r}.

15. The two-stage distributed robust model-oriented adaptive multi-faceted cutting solution system according to claim 13, wherein the second-stage objective function is
$$Q ( x , ζ ) {=}^{△} {min}_{y ∈ {ℝ}^{d , r}} {q}^{T} y ,$$
wherein q is a coefficient of the second-stage objective function, T is a corresponding transpose matrix, and a function space R^{d}→R^{r} of the second-stage infinite-dimensional decision variable y(⋅) is represented by [symbol] ^{d,r}.

16. The two-stage distributed robust model-oriented adaptive multi-faceted cutting solution system according to claim 10, wherein the identifying refers to limiting the second-stage infinite-dimensional decision variable y to a space smaller than an original feasible domain [symbol] ^{d,r}, that is, constructing a limited second-stage infinite-dimensional decision variable space using Π⊆ [symbol] ^{d,r}, and carrying out an approximate process on a distributed robust original problem [symbol] to obtain [symbol] , wherein a result obtained after approximation is a suboptimal solution, that is, min [symbol] ≤min [symbol] .

17. The two-stage distributed robust model-oriented adaptive multi-faceted cutting solution system according to claim 10, wherein the reconstructing a model by dimensionality reduction refers to reducing a feasible domain range Π, y(ξ)=y⁰+Yξ of the second-stage infinite-dimensional decision variable y by single-plane cutting based on an idea of an approximation method, to obtain
$${min}_{x ∈ {ℝ}^{N} y ( \cdot ) ∈ Π} {c}^{T} x + \frac{1}{N} {\sum }_{i = {1}_{ζ ∈ {F}^{i} ( {ε}_{N} )}}^{N} sup {q}^{T} y ( ζ ) ,$$
Tx+Wy≥m(ζ), and h(x,y,ζ)=0, where q∈ [symbol] ^{r}, y⁰∈ [symbol] ^{r}, a decision variable matrix is Y∈ [symbol] ^{r×d}; and performing extension by inheriting the idea of the approximation method of limiting and searching for a feasible domain of the variables, to obtain a reconstructed dispatching model after the adaptive multi-faceted cutting:
$${{min}_{x ∈ {ℝ}^{N} ,}}_{{y}^{1} ( \cdot ) … {y}^{N} ( \cdot ) ∈ Π} {c}^{T} x + \frac{1}{N} {\sum }_{i = {1}_{ζ ∈ {F}^{i} ( {ε}_{N} )}}^{N} sup {q}^{T} {y}^{i} ( ζ )$$
Tx+Wy≥m(ζ), i∈[N], and h(x,y,ζ)=0, where x and y are a first-stage decision variable and the second-stage infinite-dimensional decision variable, respectively,
$$\frac{1}{N} {\sum }_{i = {1}_{ζ ∈ {F}^{i} ( {ε}_{N} )}}^{N} sup {q}^{T} {y}^{i} ( ζ )$$
is an approximated second-stage objective function, c is an objective function coefficient matrix, T and W are inequality coefficient matrices, m(ζ) is a vector of an inequality constraint, and h(x,y,ζ)=0 is an equality constraint.

18. The two-stage distributed robust model-oriented adaptive multi-faceted cutting solution system according to claim 10, wherein the dispatching strategy scheme is obtained by solving the reconstructed dispatching model by using a column-generated cutting plane method, comprising:
i) solving the reconstructed dispatching model by using a simplified model containing only a subset of variables;
ii) gradually increasing variables in a current solution that have negative reduced costs or contribute to an improvement of an objective function, that is, generating columns, to find an optimal solution of linear relaxation and eliminate a current non-integer solution without eliminating any integer feasible solution;
iii) when the optimal solution of linear relaxation does not satisfy a integer constraint, generating a new constraint by using a reduced constraint method, and then returning to Step ii until an integer solution satisfying all constraints is found or a problem is determined to have no solution; and
iv) when there are no new generated columns, that is, all columns have non-negative reduction costs and the current solution satisfies all integer constraints, obtaining the dispatching strategy scheme.
